(19) United States
(12) Patent Application Publication
(10) Pub. No.: US 2008/0053745 A1
(43) Pub. Date: Mar. 6, 2008

(54) Electroacoustic transducer and diaphragm

(76) Inventors: Takumu Tada, Kanagawa-ken (JP); Takayuki Iseki, Kanagawa-ken (JP); Shinichi Hirose, Kanagawa-ken (JP); Yoshiaki Suzuki, Kanagawa-ken (JP)

Correspondence Address: THE NATH LAW GROUP, 112 South West Street, Alexandria, VA, 22314, US

(21) Appl. No.: 11/892,810

(22) Filed: Aug. 27, 2007

(30) Foreign Application Priority Data
Aug. 30, 2006 (JP) P2006-234269
Aug. 30, 2006 (JP) P2006-234272
Aug. 30, 2006 (JP) P2006-234278
Jun. 8, 2007 (JP) P2007-152576
Jun. 8, 2007 (JP) P2007-152577
Jun. 14, 2007 (JP) P2007-157835

(51) Int. Cl. G10K 13/00; H04R 1/00

(52) U.S. Cl. 181/165; 381/420; 381/424

(57) ABSTRACT

An electroacoustic transducer includes a magnetic circuit; a frame enclosing the magnetic circuit; and a diaphragm including a center vibrating portion and an outer circumferential vibrating portion, the diaphragm comprising: a first plate thickness area including an entirety of the center vibrating portion, having a double-layer structure of a wood sheet and a reinforcement sheet; and a second plate thickness area including the edge portion of the outer circumferential vibrating portion, having a plate thickness thinner than a thickness of the first plate thickness area, and having a single-layer structure of the reinforcement sheet.

### CROSS REFERENCE TO RELATED APPLICATIONS AND INCORPORATION BY REFERENCE

This application is based upon and claims the benefit of priority from the prior Japanese Patent Applications No. P2006-234269, P2006-234272, and P2006-234278 filed on Aug. 30, 2006, P2007-152576 and P2007-152577 filed on Jun. 8, 2007, and P2007-157835 filed on Jun. 14, 2007; the entire contents of which are incorporated herein by reference.

### BACKGROUND OF THE INVENTION

1. Field of the Invention

The present invention relates to a diaphragm, and a full-range electroacoustic transducer including headphones and the like.

2. Description of the Related Art

In recent years, one using natural wood as a raw material of a diaphragm has been known. The reason to use the wood as the raw material of the diaphragm is that natural timbre intrinsic to the wood is obtained in addition to that the wood has comprehensively excellent characteristics. For example, the wood has higher acoustic velocity, larger rigidity and Young's modulus than those of paper and resin. The wood also has a larger internal loss and a smaller density (more lightness) than those of metal. In addition, adoption of the wood can help the diaphragm achieve an improvement of an exterior appearance thereof, and the wood has an effect to give high quality to the diaphragm. From these facts, as one of the raw materials of the diaphragm, the wood has attracted attention.

As shown in FIG. 1, when an audio is reproduced over a wide band from a bass band to a treble band, a diaphragm 111 enclosed in a frame 113 is used. The diaphragm 111 includes a dome-like center vibrating portion 101 and an outer circumferential vibrating portion 103 disposed to be integrally continuous with an outer circumference of the center vibrating portion 101. The entire band from the bass band to the treble band is covered by a combination of the center vibrating portion 101 and the outer circumferential vibrating portion 103. A common frequency response (output sound pressure frequency characteristics) is shown in FIG. 2.

The frequency response shown in FIG. 2 is obtained by automatically measuring sound pressure levels at a point on a reference axis, which is apart from the diaphragm by 1 m, so that the sound pressure levels can be a continuous curve correspondingly to frequencies. In the frequency response as shown in FIG. 2, the frequency band to be reproduced is referred to as an effective frequency band FB. Such a frequency range between a lower reproduction limit L and a higher reproduction limit H, in which the output sound pressure levels drop by −10 dB in a range between a low resonant frequency f0 representing a limit of the bass band and a high resonant frequency fh representing a limit of the treble band, is shown. The characteristics are divided into two, which are: a piston vibration band PB that is flat; and a divided vibration band DB where the diaphragm vibrates complicatedly. In the entire-band type, the entire band from the lower reproduction limit L to the higher reproduction limit H is used.

In the bass band, the frequency characteristics of the output sound pressure become substantially flat since the characteristics concerned belong to the piston vibration band PB where the diaphragm vibrates from an edge portion 105 as a point of support. In a midrange band, influences appear individually on coupling portions which become a boundary between the edge portion 105 on the periphery of the diaphragm and the outer circumferential vibrating portion 103 thereof and a boundary between the center vibrating portion 101 of the diaphragm and the outer circumferential vibrating portion 103 thereof. Specifically, owing to a resonance, antiphase vibrations as shown by arrows a and b of FIG. 1 occur, sounds are mutually cancelled, and a midrange trough called a dip d is generated. In the treble band, it becomes impossible for the diaphragm to make the piston vibrations, and the respective portions of the diaphragm enter the divided vibration band DB, and accordingly, many peak dips are generated. In such a treble band limit, high resonances occur at frequencies mainly determined by stiffness and mass of the center portion of the diaphragm and by a mass of a voice coil 107, and the sound pressure drops radically from, as a last point, a peak at this higher limit frequency (higher reproduction limit H).

In order to solve the problems, Japanese Unexamined Patent Application Laid-Open (Koukai) No. 2002-152885 (hereinafter called “JP 2002-152885”) has been known. JP 2002-152885 discloses that a diaphragm material with internal loss characteristics of 0.02 or more is used in order to expand the treble band. Accordingly, a frequency band of 20 kHz or more is made reproducible by the divided vibrations of the diaphragm. Alternatively, Japanese Unexamined Patent Application Laid-Open (Koukai) No. 2005-204215 (hereinafter called “JP 2005-204215”) has also been known. In JP 2005-204215, the antiphase vibrations on the edge portion in the midrange band are suppressed by using an elastic member for fixing and supporting the edge portion whereby the dip d is made small.

As described above, in the diaphragm of the full-range type, the problems occur particularly from the midrange band to the treble band. However, in JP 2002-152885, which improves the midrange band, there are malfunctions that it is necessary to use such a special material with the internal loss characteristics of 0.02 or more. Moreover, adoption of JP 2002-152885 does not result very much in an improvement of audio frequency band other than the treble band. Furthermore, JP 2002-152885 does not consider achieving the improvement of the appearance quality at all.

In JP 2005-204215, which supports the edge portion by the elastic member, an improvement of the vibration characteristics of the edge portion can be achieved. However, on the other hand, adoption of JP 2005-204215 does not result in an improvement of the antiphase occurring on the boundary between the center vibrating portion and the outer circumferential vibrating portion. In addition, JP 2005-204215 has a malfunction from the midrange band to the treble band, and does not consider achieving the improvement of the appearance quality at all, either.

### SUMMARY OF THE INVENTION

The present invention provides an electroacoustic transducer and a diaphragm, which are excellent in appearance quality, and are made capable of obtaining the natural timbre intrinsic to the wood, and are made capable of achieving the audio quality improvement of the audio frequency from the midrange to the treble ranges.

An aspect of the present invention inheres in an electroacoustic transducer encompassing a magnetic circuit; a frame enclosing the magnetic circuit; and a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm including: a first plate thickness area including an entirety of the center vibrating portion, having a double-layer structure of a wood sheet and a reinforcement sheet; and a second plate thickness area including the edge portion of the outer circumferential vibrating portion, having a plate thickness thinner than a thickness of the first plate thickness area, and having a single-layer structure of the reinforcement sheet.

Another aspect of the present invention inheres in an electroacoustic transducer encompassing a magnetic circuit; a frame enclosing the magnetic circuit; and a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm including: a first plate thickness area including an entirety of the center vibrating portion and a specified area of the outer circumferential vibrating portion being connected to the center vibrating portion, having a double-layer structure of a wood sheet and a reinforcement sheet; and a second plate thickness area including, an area other than the specified area of the outer circumferential vibrating portion, having a plate thickness thinner than a thickness of the first plate thickness area, and having a single-layer structure of the reinforcement sheet.

Still another aspect of the present invention inheres in a diaphragm encompassing a center vibrating portion having a substantial dome shape in a cross section; and an outer circumferential vibrating portion having a substantial dome shape in the cross section and formed over an entire outer circumference of the center vibrating portion, wherein the center vibrating portion and the outer circumferential vibrating portion including: a first plate thickness area including an entirety of the center vibrating portion, having a double-layer structure of a wood sheet and a reinforcement sheet; and a second plate thickness area including the edge portion of the outer circumferential vibrating portion, having a plate thickness thinner than a thickness of the first plate thickness area, and having a single-layer structure of the reinforcement sheet.

Still another aspect of the present invention inheres in a diaphragm encompassing a center vibrating portion having a substantial dome shape in a cross section; and an outer circumferential vibrating portion having a substantial dome shape in the cross section and formed over an entire outer circumference of the center vibrating portion, wherein the center vibrating portion and the outer circumferential vibrating portion including: a first plate thickness area including an entirety of the center vibrating portion and a specified area of the outer circumferential vibrating portion being connected to the center vibrating portion, having a double-layer structure of a wood sheet and a reinforcement sheet; and a second plate thickness area including an area other than the specified area of the outer circumferential vibrating portion, having a plate thickness thinner than a thickness of the first plate thickness area, and having a single-layer structure of the reinforcement sheet.

Still another aspect of the present invention inheres in an electroacoustic transducer encompassing a magnetic circuit; a frame enclosing the magnetic circuit; and a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm including: a first plate thickness area including an entirety of the center vibrating portion, having a laminated structure of a wood sheet, a paper sheet and a synthetic resin film; and a second plate thickness area including the edge portion of the outer circumferential vibrating portion, having a plate thickness thinner than a thickness of the first plate thickness area, and having a single-layer structure of a synthetic resin film.

Still another aspect of the present invention inheres in an electroacoustic transducer encompassing a magnetic circuit; a frame enclosing the magnetic circuit; and a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm including: a first plate thickness area including an entirety of the center vibrating portion and a specified area of the outer circumferential vibrating portion being connected to the center vibrating portion, having a laminated structure of a wood sheet, a paper sheet and a synthetic resin film; and a second plate thickness area including an area other than the specified area of the outer circumferential vibrating portion, having a plate thickness thinner than a thickness of the first plate thickness area, and having a single-layer structure of a synthetic resin film.

Still another aspect of the present invention inheres in a diaphragm encompassing a center vibrating portion having a substantial dome shape in a cross section; and an outer circumferential vibrating portion having a substantial dome shape in the cross section and formed over an entire outer circumference of the center vibrating portion, wherein the center vibrating portion and the outer circumferential vibrating portion including: a first plate thickness area including an entirety of the center vibrating portion, having a laminated structure of a wood sheet, a paper sheet and a synthetic resin film; and a second plate thickness area including the edge portion of the outer circumferential vibrating portion, having a plate thickness thinner than a thickness of the first plate thickness area, and having a single-layer structure of the synthetic resin film.

Still another aspect of the present invention inheres in a diaphragm encompassing a center vibrating portion having a substantial dome shape in a cross section; and an outer circumferential vibrating portion having a substantial dome shape in the cross section and formed over an entire outer circumference of the center vibrating portion, wherein the center vibrating portion and the outer circumferential vibrating portion including: a first plate thickness area including an entirety of the center vibrating portion and a specified area of the outer circumferential vibrating portion being connected to the center vibrating portion, having a laminated structure of a wood sheet, a paper sheet and a synthetic resin film; and a second plate thickness area including an area other than the specified area of the outer circumferential vibrating portion, having a plate thickness thinner than a thickness of the first plate thickness area, and having a single-layer structure of the synthetic resin film.

Still another aspect of the present invention inheres in an electroacoustic transducer encompassing a magnetic circuit; a frame enclosing the magnetic circuit; and a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm including: a first plate thickness area including a center portion of the center vibrating portion; a second plate thickness area including the edge portion of the outer circumferential vibrating portion, having a plate thickness thinner than a thickness of the first plate thickness area; and a third plate thickness area between the first and second plate thickness areas, including a specified area of the center vibrating portion being connected to the outer circumferential vibrating portion, and having a plate thickness thicker than the first plate thickness area.

Still another aspect of the present invention inheres in an electroacoustic transducer encompassing a magnetic circuit; a frame enclosing the magnetic circuit; and a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm including: a first plate thickness area including a center portion of the center vibrating portion; a second plate thickness area including the edge portion of the outer circumferential vibrating portion, having a plate thickness thinner than a thickness of the first plate thickness area; and a third plate thickness area between the first and second plate thickness areas, including a specified area of the outer circumferential vibrating portion being connected to the center vibrating portion, and having a plate thickness thicker than the first plate thickness area.

Still another aspect of the present invention inheres in an electroacoustic transducer encompassing a magnetic circuit; a frame enclosing the magnetic circuit; and a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm including a first plate thickness area including a center portion of the center vibrating portion; a second plate thickness area including the edge portion of the outer circumferential vibrating portion, having a plate thickness thinner than a thickness of the first plate thickness area; and a third plate thickness area between the first and second plate thickness areas, including a first specified area of the center vibrating portion being connected to the outer circumferential vibrating portion and a second specified area of the outer circumferential vibrating portion being connected to the center vibrating portion, and having a plate thickness thicker than the first plate thickness area.

Still another aspect of the present invention inheres in a diaphragm encompassing a center vibrating portion having a substantial dome shape in a cross section; and an outer circumferential vibrating portion having a substantial dome shape in the cross section and formed over an entire outer circumference of the center vibrating portion, wherein the center vibrating portion and the outer circumferential vibrating portion including: a first plate thickness area including a center portion of the center vibrating portion; a second plate thickness area including the edge portion of the outer circumferential vibrating portion, having a plate thickness thinner than a thickness of the first plate thickness area; and a third plate thickness area between the first and second plate thickness areas, including a specified area of the center vibrating portion being connected to the outer circumferential vibrating portion, and having a plate thickness thicker than the first plate thickness area.

Still another aspect of the present invention inheres in a diaphragm encompassing a center vibrating portion having a substantial dome shape in a cross section; and an outer circumferential vibrating portion having a substantial dome shape in the cross section and formed over an entire outer circumference of the center vibrating portion, wherein the center vibrating portion and the outer circumferential vibrating portion including: a first plate thickness area including a center portion of the center vibrating portion; a second plate thickness area including the edge portion of the outer circumferential vibrating portion, having a plate thickness thinner than a thickness of the first plate thickness area; and a third plate thickness area between the first and second plate thickness areas, including a specified area of the outer circumferential vibrating portion being connected to the center vibrating portion, and having a plate thickness thicker than the first plate thickness area.

Still another aspect of the present invention inheres in a diaphragm encompassing a center vibrating portion having a substantial dome shape in a cross section; and an outer circumferential vibrating portion having a substantial dome shape in the cross section and formed over an entire outer circumference of the center vibrating portion, wherein the center vibrating portion and the outer circumferential vibrating portion including: a first plate thickness area including a center portion of the center vibrating portion; a second plate thickness area including the edge portion of the outer circumferential vibrating portion, having a plate thickness thinner than a thickness of the first plate thickness area; and a third plate thickness area between the first and second plate thickness areas, including a first specified area of the center vibrating portion being connected to the outer circumferential vibrating portion and a second specified area of the outer circumferential vibrating portion being connected to the center vibrating portion, and having a plate thickness thicker than the first plate thickness area.

Still another aspect of the present invention inheres in an electroacoustic transducer encompassing a magnetic circuit; a frame enclosing the magnetic circuit; and a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm including: a first plate thickness area including an entirety of the center vibrating portion; and a second plate thickness area including the edge portion of the outer circumferential vibrating portion, having a plate thickness thinner than a thickness of the first plate thickness area.

Still another aspect of the present invention inheres in an electroacoustic transducer encompassing a magnetic circuit; a frame enclosing the magnetic circuit; and a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm including: a first plate thickness area including an entirety of the center vibrating portion and a specified area of the outer circumferential vibrating portion being connected to the center vibrating portion; and a second plate thickness area including an area other than the specified area of the outer circumferential vibrating portion, having a plate thickness thinner than a thickness of the first plate thickness area.

Still another aspect of the present invention inheres in a diaphragm encompassing a center vibrating portion having a substantial dome shape in a cross section; and an outer circumferential vibrating portion having a substantial dome shape in the cross section and formed over an entire outer circumference of the center vibrating portion, wherein the center vibrating portion and the outer circumferential vibrating portion including: a first plate thickness area including an entirety of the center vibrating portion; and a second plate thickness area including the edge portion of the outer circumferential vibrating portion, having a plate thickness thinner than a thickness of the first plate thickness area.

Still another aspect of the present invention inheres in a diaphragm encompassing a center vibrating portion having a substantial dome shape in a cross section; and an outer circumferential vibrating portion having a substantial dome shape in the cross section and formed over an entire outer circumference of the center vibrating portion, wherein the center vibration portion and the outer circumferential vibrating portion including: a first plate thickness area including an entirety of the center vibrating portion and a specified area of the outer circumferential vibrating portion being connected to the center vibrating portion; and a second plate thickness area including an area other than the specified area of the outer circumferential vibrating portion, having a plate thickness thinner than a thickness of the first plate thickness area.

Still another aspect of the present invention inheres in an electroacoustic transducer encompassing a magnetic circuit; a frame enclosing the magnetic circuit; and a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm including: a first area including an entirety of the center vibrating portion; and a second area including the edge portion of the outer circumferential vibrating portion, having flexibility, and formed of a material softer than a material of the first area.

Still another aspect of the present invention inheres in a n electroacoustic transducer encompassing a magnetic circuit; a frame enclosing the magnetic circuit; and a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm including: a first area including an entirety of the center vibrating portion and a specified area of the outer circumferential vibrating portion being connected to the center vibrating portion; and a second area including an area other than the specified area of the outer circumferential vibrating portion, having flexibility, and formed of a material softer than a material of the first area.

Still another aspect of the present invention inheres in a diaphragm encompassing a center vibrating portion having a substantial dome shape in a cross section; and an outer circumferential vibrating portion having a substantial dome shape in the cross section and formed over an entire outer circumference of the center vibrating portion, wherein the center vibrating portion and the outer circumferential vibrating portion including: a first area including an entirety of the center vibrating portion; and second area including the edge portion of the outer circumferential vibrating portion, having flexibility, and formed of a material softer than a material of the first area.

Still another aspect of the present invention inheres in a diaphragm encompassing a center vibrating portion having a substantial dome shape in a cross section; and an outer circumferential vibrating portion having a substantial dome shape in the cross section and formed over an entire outer circumference of the center vibrating portion, wherein the center vibrating portion and the outer circumferential vibrating portion including: a first area including an entirety of the center vibrating portion and a specified area of the outer circumferential vibrating portion being connected to the center vibrating portion; and a second area including an area other than the specified area of the outer circumferential vibrating portion, having flexibility, and formed of a material softer than a material of the first area.

### BRIEF DESCRIPTION OF THE DRAWINGS

FIG. 1 is an explanatory diagram illustrating an example of an electroacoustic transducer according to the related art;

FIG. 2 is a graph illustrating an example of a common frequency response (output sound pressure frequency characteristics);

FIG. 3 is a cross-sectional view illustrating an electroacoustic transducer according to a first embodiment of the present invention;

FIG. 4 is an explanatory diagram illustrating an example of a wood sheet fabricated by slicing a log according to the first embodiment of the present invention;

FIG. 5 is a table illustrating an example of materials of a diaphragm according to the present invention;

FIG. 6A is a cross-sectional view illustrating an adhered sheet according to the first embodiment of the present invention;

FIG. 6B is a cross-sectional view illustrating a press formed adhered sheet according to the first embodiment of the present invention;

FIG. 6C is a cross-sectional view illustrating a diaphragm according to the first embodiment of the present invention;

FIG. 7A is a cross-sectional view illustrating an adhered sheet according to the first embodiment of the present invention;

FIG. 7B is a top plan view illustrating a diaphragm according to the first embodiment of the present invention;

FIG. 7C is a cross-sectional view illustrating the diaphragm according to the first embodiment of the present invention;

FIG. 8 is a cross-sectional view illustrating an electroacoustic transducer according to a second embodiment of the present invention;

FIG. 9 is an explanatory diagram illustrating an example of a wood sheet fabricated by slicing a log according to the second embodiment of the present invention;

FIG. 10A is a cross-sectional view illustrating an adhered sheet according to the second embodiment of the present invention;

FIG. 10B is a cross-sectional view illustrating a press formed adhered sheet according to the second embodiment of the present invention;

FIG. 10C is a cross-sectional view illustrating a diaphragm according to the second embodiment of the present invention;

FIG. 11A is a top plan view illustrating a diaphragm according to the second embodiment of the present invention;

FIG. 11B is a cross-sectional view illustrating the diaphragm according to the second embodiment of the present invention;

FIG. 12 is a cross-sectional view illustrating an electroacoustic transducer according to a third embodiment of the present invention;

FIG. 13A is a top plan view illustrating a diaphragm according to the third embodiment of the present invention;

FIG. 13B is a cross-sectional view illustrating the diaphragm according to the third embodiment of the present invention; and

FIG. 14 is a cross-sectional view illustrating a diaphragm according to the third embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings. The description of the same or similar parts and elements will be omitted or simplified. In the following descriptions, numerous details are set forth such as specific signal values, etc. to provide a thorough understanding of the present invention. However, it will be obvious to those skilled in the art that the present invention may be practiced without such specific details.

### First Embodiment

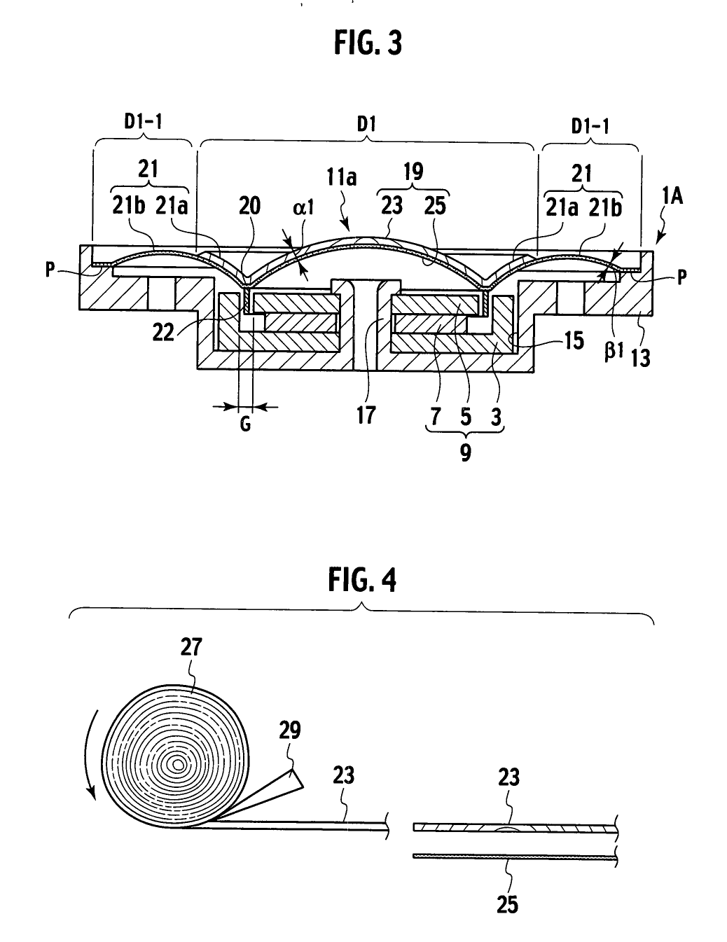

As shown in FIG. 3, an electroacoustic transducer 1A according to a first embodiment of the present invention includes: a magnetic circuit 9 including a magnetic pole (yoke) 3, a center pole 5, and a magnet 7; and a diaphragm 11a disposed above the magnetic circuit 9.

The magnetic pole 3, the center pole 5, and the magnet 7 are fitted to a columnar protrusion 17 erected from a recessed portion 15 of a frame 13, and are enclosed in the recessed portion 15 while having a predetermined gap G between the magnetic pole 3 and the center pole 5.

The diaphragm 11a includes: a center vibrating portion 19 having a substantial dome shape in cross section; and an outer circumferential vibrating portion 21 formed to be integrally continuous with an outer circumference of the center vibrating portion 19. Onto a back surface of the diaphragm 11a, which becomes a coupling portion 20 continuous from the center vibrating portion 19 to the outer circumferential vibrating portion 21, a voice coil 22 is joined and supported through an adhesive while being centered by drop-in in the gap G.

The outer circumferential vibrating portion 21 includes: a plate thickness portion 21a with the same thickness as that of the center vibrating portion 19; and an edge portion 21b with a plate thickness thinner than the thickness of the plate thickness portion 21a. A circumferential end edge P of the edge portion 21b is adhered and supported to an outer circumferential edge of the frame 13 by adhering means such as the adhesive.

A thick plate thickness area D1 includes a laminated sheet in which a wood sheet 23 made of natural wood and a reinforcement sheet 25 are stacked on each other. The thick plate thickness area D1 is set to have such a thickness α1 at which antiphase vibrations are suppressed to be small in a midrange band and complicated divided vibrations are suppressed to be small in a treble band. The thickness α1 is not particularly limited; however, can be set, for example, at approximately from 5 μm to 250 μm from a viewpoint of managing weight of the diaphragm 11a and ensuring stiffness thereof, for example, in the case of using the diaphragm 11a for a headphone and an earphone.

A thin plate thickness area D1-1 that becomes the edge portion 21b includes only the reinforcement sheet 25 as one constituent of the laminated sheet, and is set at a thickness β1 at which the entirety of the diaphragm 11a enters a piston vibration band. The thickness β1 is not particularly limited; however, a range of the thickness is regulated from a viewpoint of managing the weight of the diaphragm 11a and a Young's modulus thereof, for example, in the case of using the diaphragm 11a for the headphone and the earphone. The thickness β1 can be set, for example, at approximately from 4 μm to 40 μm.

For example, as shown in FIG. 4, the wood sheet 23 is fabricated by bringing a cutting blade 29 into contact with a log-like wood 27 while rotating the log-like wood 27 as shown by arrow and performing rotary slice (rotary lathe) thereof. The wood sheet 23 may be fabricated by performing a slice process for a flat-grained plate material or a straight-grained plate material. For a thickness of the wood sheet 23, a wide thickness range approximately from 10 μm to 600 Mm is usable. However, the thickness of the wood sheet 23 is set within a range of preferably 10 μm to 150 μm, particularly preferably, from 20 μm to 80 μm in order to set the weight, stiffness and press formability of the diaphragm.

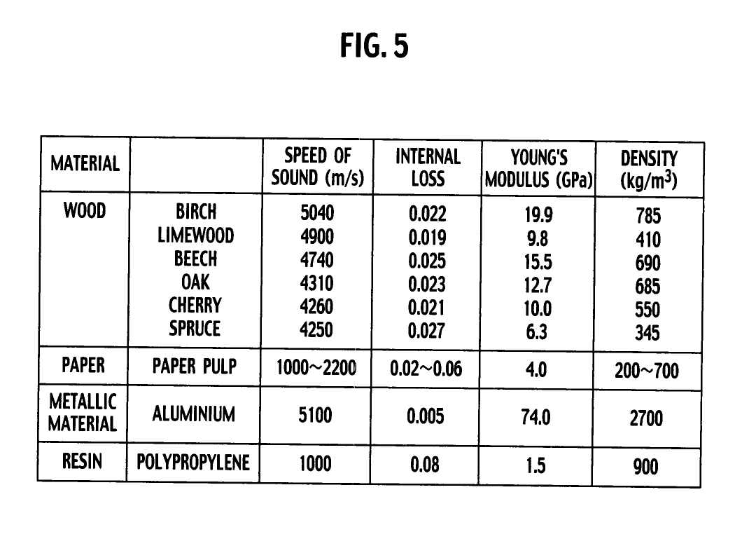

For the natural wood for use, a material is preferable, which satisfies the respective conditions of easiness of fabrication, required acoustic characteristics, and the like in addition to that a vessel density is even and small, the length of the vessels are short, wood fiber is long, growth of a earlywood (springwood) is slow, and so on. As the material concerned, as shown in FIG. 5, both broadleaf woods and conifers are usable. However, preferably, the broadleaf woods are used. For example, birchwoods (genus Betula) such as monarch birch and gold birch, a Japanese big-leaf magnolia, maple woods (genus Acer) such as sugar maple and hard maple can be suitably used.

For the reinforcement sheet 25, a highly heat-resistant one in which mechanical strength such as tensile strength is high is used. As an artificial material, nonwoven fabric in which vinylon and pulp are mixed, and the like are suitably used. As a natural material, Japanese paper (washi) from gampi tree, paper mulberry, and the like are also suitably used since mechanical strengths thereof are strong. The reinforcement sheet may be directly used, or may be subjected to treatment such as resin immersion in order to increase the mechanical strength thereof, and further to obtain adhering means.

Moreover, a film made of a synthetic resin material is usable as the reinforcement sheet 25. For example, polyethylene terephthalate (PET), polyethylene naphthalate (PEN), polyetherimide (PEI), polyimide (PI), and the like are frequently used since mechanical strengths thereof are strong, it is easy to mold and process these synthetic resins, and so on.

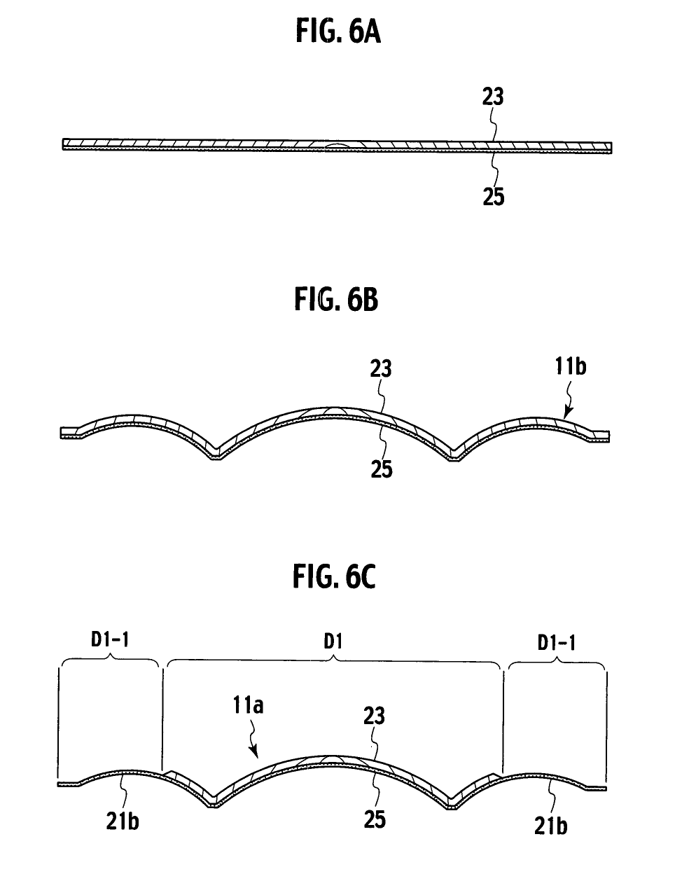

As shown in FIG. 6A, the wood sheet 23 and the reinforcement sheet 25 are stacked on each other by the adhering means such as the adhesive, whereby the laminated sheet is formed. The laminated sheet concerned is subjected to hot press forming by male-type and female-type press machines (dies, not shown) including heating means such as a heater, whereby a diaphragm 11b shown in FIG. 6B is formed. The diaphragm 11b is made of a laminated sheet on which the wood sheet 23 is stacked over the entire area. On the thin plate thickness area D1-1 that becomes the edge portion 21b, the wood sheet 23 is ground and removed, for example, by thrusting abrasive paper thereon. In such a way, as shown in FIG. 6C, the diaphragm 11a including the edge portion 21b composed only of the reinforcement sheet 25 can be manufactured.

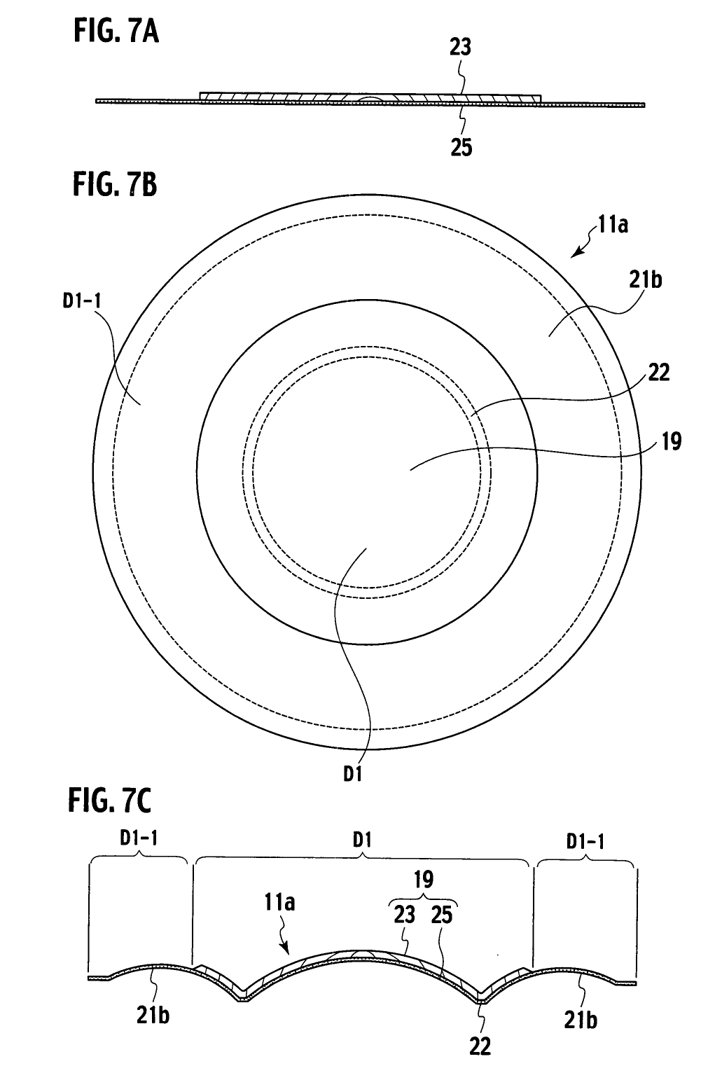

Note that it is also possible to form the thin plate thickness area D1-1 that becomes the edge portion 21b also by laminating the wood sheet 23 with a predetermined dimension on the reinforcement sheet 25, for example, as shown in FIG. 7A, besides using the means for grinding and removing the wood sheet 23. In this case, the reinforcement sheet 25 with a dimension obtained by summing up an outer diameter of the plate thickness area D1 after being press formed and an outer diameter of the plate thickness area D1-1 after being press formed (that is, the sum of lengths of the plate thickness area D1 and the two plate thickness areas D1-1 in the horizontal direction in the drawing, for example, in the case of the diaphragm 11a shown in FIG. 7C) is prepared. The wood sheet 23 fabricated to the dimension that becomes the outer diameter of the plate thickness area D1 after being press formed and the prepared reinforcement sheet 25 are stacked on each other, the laminated sheet is thereby formed, and is subjected to the hot press forming, and thereafter, an excessive outer circumferential portion is removed therefrom. In such a way, as shown in FIG. 7B and FIG. 7C, it is possible to obtain the edge portion 21b in which the plate thickness area D1-1 is composed only of the reinforcement sheet 25.

In accordance with the electroacoustic transducer 1A according to the first embodiment, appearance of surfaces of the diaphragm 11a is enhanced by such a woodgrain tone by the wood sheet 23. Thus, high appearance qualities can be obtained. In addition, the natural timbre intrinsic to the wood can be obtained.

Meanwhile, the diaphragm 11a, which includes the center vibrating portion 19 and the outer circumferential vibrating portion 21, enters the piston vibration band where the diaphragm 11a concerned vibrates entirely from, as the point of support, the edge portion 21 formed into the thin plate. Accordingly, the frequency characteristics of the output sound pressure can be made flat. Moreover, in the midrange band, it becomes possible to suppress the antiphase vibrations to be small, and to improve the sound pressure dip d. Furthermore, in the treble band, it becomes possible to suppress the complicated divided vibrations of the diaphragm 11a to be small, and to achieve the improvement of the peak dip.

Note that, in FIG. 3, the wood sheet 23 is formed so as to be extended to a specified area (plate thickness portion 21a) continuous with the coupling portion of the outer circumferential vibrating portion 21 to the center vibrating portion 19; however, the wood sheet 23 just needs to be formed so as to include at least the entirety of the center vibrating portion 19. Specifically, the wood sheet 23 may be formed only on the center vibrating portion 19.

Desirably, the center vibrating portion 19 is formed of a material in which sound propagation velocity on a surface is fast. As shown in FIG. 5, the wood sheet 23 is extremely suitable since sound propagation velocity equivalent to that of metal can be obtained by such a lightweight material having a density similar to that of paper. Moreover, the wood sheet 23 includes the wood fiber, and accordingly, has anisotropy in a structure thereof, has the internal loss of which magnitude is appropriate, and can suppress the occurrence of the resonant vibrations and the divided vibrations. However, in terms of managing the weight, when the wood sheet 23 is processed to be as thin as possible, the strength thereof in a direction perpendicular to the fiber is weakened, and accordingly, the reinforcement sheet 25 that reinforces the wood sheet 23 becomes necessary. Hence, plural layers as a double-layer stack structure are employed for the center vibrating portion 19, whereby an appropriate acoustic effect can be obtained. Moreover, the plate thickness area is expanded to the coupling portion 20, thus making it possible to obtain stable piston vibrations.

Meanwhile, the outer circumferential vibrating portion 21 can be defined as a spring portion when the diaphragm makes the piston vibrations as described above, and accordingly, it is desirable to select physical property values of the reinforcement sheet 25 within a certain range. Therefore, a single-layer structure of the reinforcement sheet 25 is suitable, which is formed of a paper sheet or a synthetic resin film, which is thin and lightweight, has hermetical sealing property, has appropriate rigidity and shape restorability, and good press formability.

### Second Embodiment

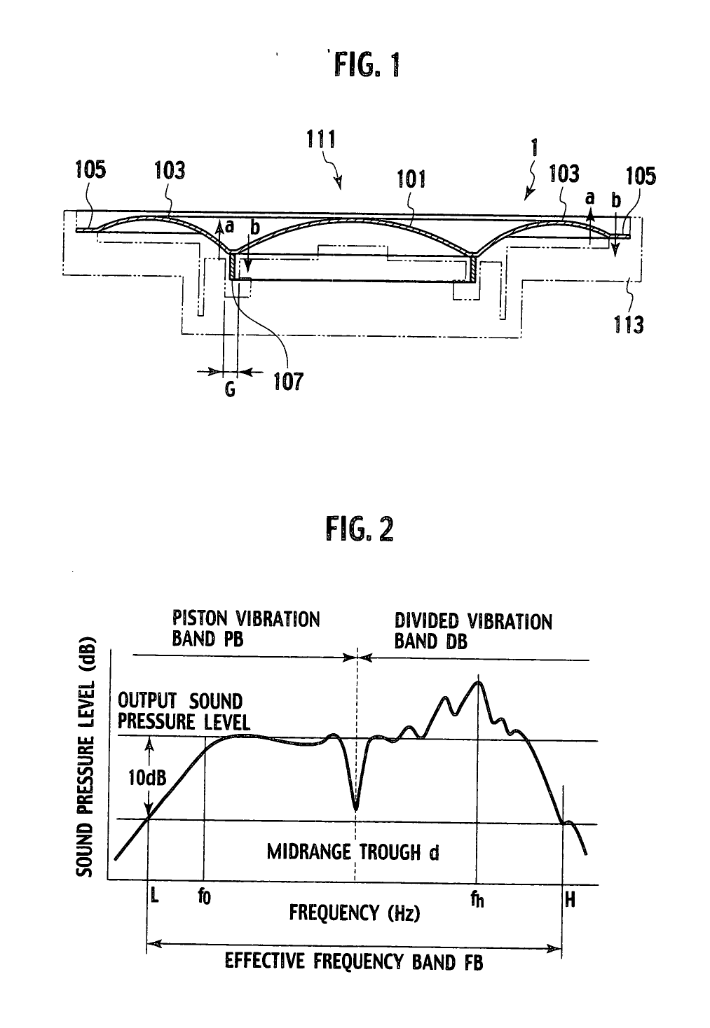

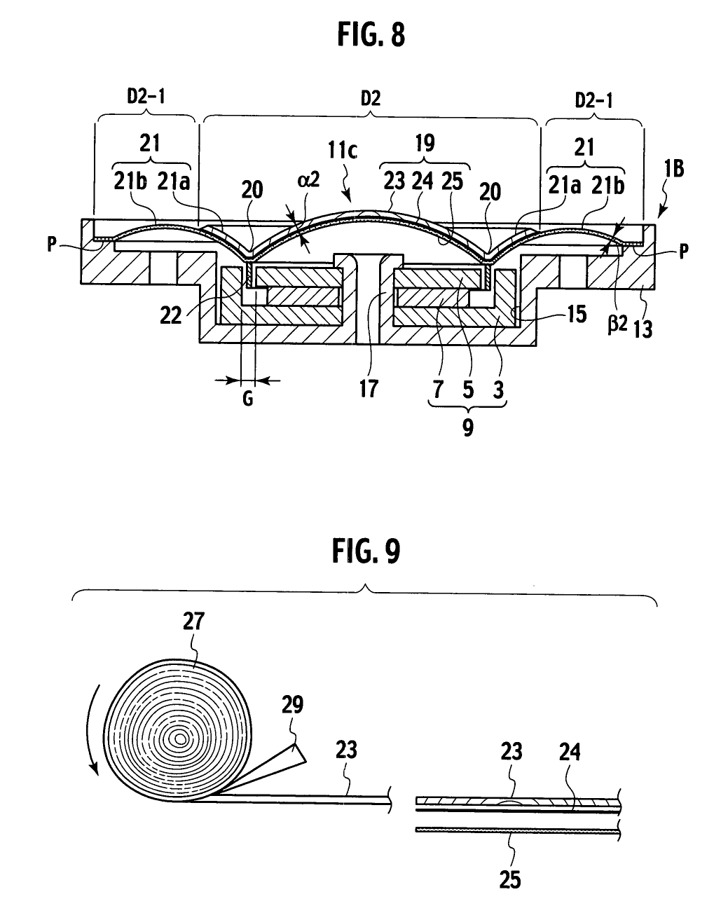

As shown in FIG. 8, an electroacoustic transducer 1B according to a second embodiment is different from the electroacoustic transducer 1 shown in FIG. 1 in including a diaphragm 11c.

The diaphragm 11c includes: the center vibrating portion 19 having a substantial dome shape in cross section; and the outer circumferential vibrating portion 21 having a substantial dome shape in cross section, which is formed on the outer circumference of the center vibrating portion 19. The diaphragm 11c has a shape in which the center vibrating portion 19 is integrally continuous with the outer circumferential vibrating portion 21 by the coupling portion 20. Onto a back surface of the coupling portion 20, a voice coil 22 is joined and supported through the adhesive while being centered by the drop-in in the gap G. Meanwhile, the outer circumferential vibrating portion 21 is composed of a plate portion 21a with the same thickness as that of the center vibrating portion 19, and the edge portion 21b with a plate thickness thinner than the thickness of the plate portion 21a. A support structure is adopted, in which the circumferential end edge P of the edge portion 21b is adhered onto the outer circumferential edge of the frame 13 by the adhering means such as the adhesive.

The diaphragm 11c shown in FIG. 8 includes the first plate thickness area D2 defined to include the entirety of the center vibrating portion 19 and the coupling portion 20, and of the second plate thickness area D2-1 which is defined to include the edge portion 21b of the outer circumferential vibrating portion 21 and has a plate thickness thinner than the plate thickness of the first plate thickness area D2.

The first plate thickness area D2 is formed into a stack structure in which the wood sheet 23 made of the natural wood, a paper sheet 24, and a synthetic resin film 25 are stacked on one another. Upper and lower limits of the outer diameter of the first plate thickness area D2 are regulated under conditions where the outer diameter should be as small as possible in terms of managing the weight, the outer diameter should be a size enough to give sufficient rigidity to the coupling portion, and the first plate thickness area D2 should not be overlapped with a corrugation area usually formed on the outer circumferential vibrating portion. A thickness of the first plate thickness area D2 is set at a thickness α2 at which the vibrations owing to the antiphase are suppressed to be small in the midrange band and the complicated divided vibrations are suppressed to be small in the treble band.

It is an important condition that the diaphragm for use in the headphone and the earphone is lightweight. Accordingly, from a viewpoint of managing the weight and ensuring the stiffness, for example, the thickness α2 can be set, for example, at approximately from 5 Mm to 250 μm, more preferably, approximately from 20 μm to 100 μm.

For example, as shown in FIG. 9, the wood sheet 23 is fabricated by bringing the cutting blade 29 into contact with the log-like wood 27 while rotating the wood 27 as shown by arrow and performing the rotary slice (rotary lathe) thereof. Moreover, the wood sheet 23 can also be fabricated by performing the slice process for the flat-grained plate material or the straight-grained plate material. A lower limit of the thickness of the wood sheet 23 depends on sizes of the vessel and xylem cell of the wood material.

As the material of the natural wood for use, there is mentioned the material that is easy to be fabricated as well as satisfies the conditions that that the vessel density is even and small, the length of the vessels are short, the wood fiber is long, the growth of the earlywood (springwood) is slow, and so on. In addition, considering the respective conditions of the sound characteristics, for example, that the sound propagation velocity should be fast, and that an appropriately high internal loss should be provided, one that has anisotropy and unevenness in addition to a low density and a high rigidity is the optimum. For example, as illustrated in FIG. 5, a wide range of the wood materials from the broadleaf woods to the conifers are used. The broadleaf woods are desirable as the wood materials which satisfy the above-described conditions, and in particular, it is suitable to use the birch woods (genus Betula) such as the gold birch, as a diffuse-porous wood, that grows in a cold climate area and a highland. Moreover, the Japanese big-leaf magnolia, the maple woods (genus Acer) such as the sugar maple and the hard maple can also be suitably used.

It is difficult to achieve the respective conditions of the sound characteristics only by the natural wood. Moreover, also considering the press formability and the shape stability, in this embodiment, it is preferable to adopt a stack structure in which the paper sheet 24 approximate in property to the wood is stacked on the natural wood.

It is required that the paper sheet 24 be highly heat-resistant and have high mechanical strength such as high tensile strength. As the paper sheet 24, the nonwoven fabric in which the vinylon and the pulp are mixed is used, and as the paper sheet 24 using a natural material, a sheet made of Japanese paper (washi) from gampi tree, paper mulberry, or the like is used.

Meanwhile, the second plate thickness area D2-1 is formed into a single-layer structure formed of the synthetic resin film 25. As a material of the second plate thickness area D2-1, polyethylene terephthalate (PET), polyethylene naphthalate (PEN), polyetherimide (PEI), polyimide (PI), and the like are used, and a thickness of the second plate thickness area D2-1 is set at a thickness β2 at which the entirety of the diaphragm 11c enters the piston vibration band that brings integral vibrations.

The thickness β2 is not particularly limited; however, a range of the thickness can be regulated from a viewpoint of managing the weight and ensuring the stiffness, for example, in the case of using the diaphragm for the headphone and the earphone, and preferably, the thickness β2 is set, for example, at approximately from 4 μm to 40 μm, more preferably, approximately from 6 Mm to 25 μm.

Moreover, considering the suppression of the antiphase vibrations owing to the resonance, and the complicated divided vibrations of the diaphragm in the treble band, a thickness ratio of the thickness α2 and the thickness β2 is suitably set at approximately from 1:1 to 25:1, and further, approximately from 4:1 to 15:1. By setting the thickness ratio within the above-described range, the occurrence of the dip can be further suppressed, and an acoustic diaphragm can be obtained, which achieves the audio frequency band from the midrange band to the treble band.

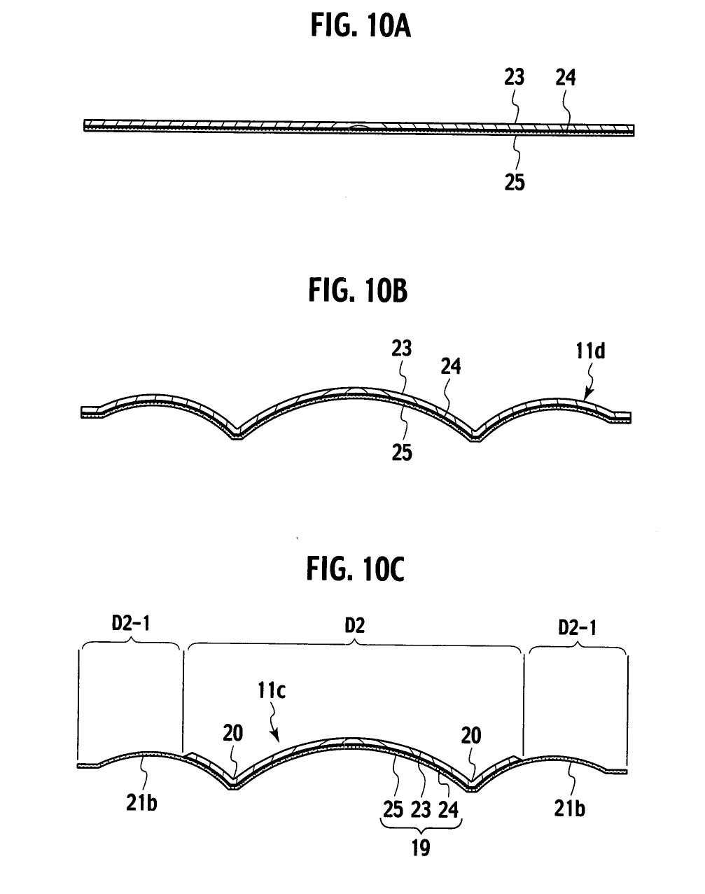

In order to fabricate the diaphragm 11c including the first plate thickness area D2 and the second plate thickness area D2-1, which are composed as described above, for example, as shown in FIG. 10A, the wood sheet 23, the paper sheet 24, and the synthetic resin film 25 are stacked on one another by the adhering means such as the resin immersion and the adhesive, whereby a triple-layer laminated sheet is formed. The laminated sheet concerned is subjected to the hot press forming by the male-type and the female-type press machines (dies, not shown) including the heating means such as the heater, whereby a diaphragm lid shown in FIG. 10B is obtained. The diaphragm lid shown in FIG. 10B is formed into the triple-layer stack structure in which the three layers concerned are stacked on one another over the entire region. With regard to the thin second plate thickness area D2-1 defined to include the edge portion 21b, for example, the wood sheet 23 and the paper sheet 24 are simultaneously ground and removed by thrusting the abrasive paper thereon. In such a way, as shown in FIG. 10C, a single-layer structure composed only of the synthetic resin film 25 can be made.

Note that a stacked sheet formed by performing a press process for the wood sheet 23 and the paper sheet 24 is punched to a size of the first plate thickness area D2, and the stacked sheet concerned is laminated on the previously press formed synthetic resin film 25 by using the adhering means, thus also making it possible to provide the second plate thickness area D2-1. In this case, the first plate thickness area D2 is formed into a stack structure composed of the wood sheet 23, the paper sheet 24, and the synthetic resin film 25.

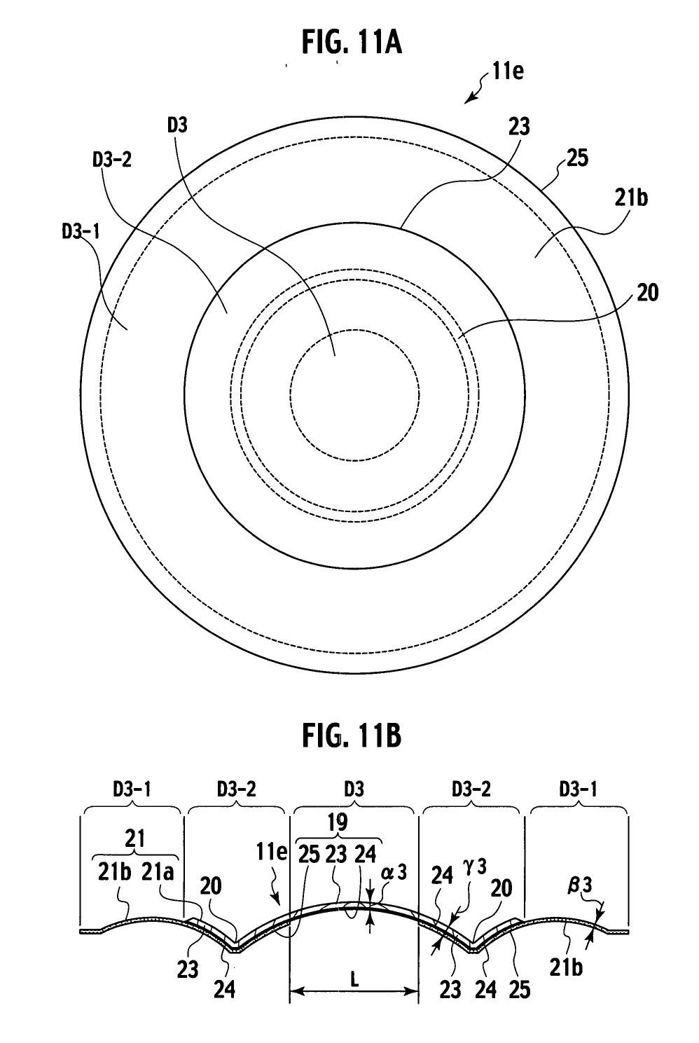

As shown in FIG. 11A and FIG. 11B, the synthetic resin film 25 of the center vibrating portion 19 is removed over a fixed area L, and also in such a way, the first plate thickness area D3 having a double-layer laminated structure composed of the wood sheet 23 and the paper sheet 24 may be formed on a center portion of the center vibrating portion 19. With regard to the fixed area L, when a diameter of a diaphragm 11e becomes large; for example, becomes ø30 mm or more, an influence of the resin film of the center vibrating portion on the entire weight becomes large, and accordingly, it is desirable to remove the synthetic resin film 25 on the fixed area L from a viewpoint of managing the weight. The maximum diameter of the fixed area L just needs to be a size enough to ensure, in a rising portion from the coupling portion to the center vibrating portion side, an overlap width when the synthetic resin sheet 25 is adhered onto the stacked sheet.

In the example shown in FIGS. 11A and 11B, the second plate thickness area D3-1 that becomes the edge portion 21b is formed into a single-layer structure composed of the synthetic resin film 25. It is preferable that the diaphragm 11e of FIGS. 11A and 11B further include a third plate thickness area D3-2 including the coupling portion 20.

The third plate thickness area D3-2 is located between the first plate thickness area D3 and the second plate thickness area D3-1, and is formed to be thicker than the first plate thickness area D3 and the second plate thickness area D3-1. A thickness of the third plate thickness area D3-2 is set at a thickness y3 at which the entirety of the diaphragm 11e enters the piston vibration band where the diaphragm concerned vibrates constantly.

The thickness γ3 is not particularly limited; however, considering the required weight, stiffness, and the like, the thickness γ3 can be preferably set, for example, at approximately from 10 Mm to 200 μm, for example, in the case of using the diaphragm for the headphone and the earphone. Moreover, considering the suppression of the antiphase vibrations owing to the resonance, and the complicated divided vibrations of the diaphragm in the treble band, a thickness ratio α3:β3:γ3 of the thickness α3, the thickness β3, and the thickness γ3 can be set at approximately from 1:1:2 to 25:1:35, and further, approximately from 4:1:6 to 15:1:20. By setting the thickness ratio within the above-described range for example, the occurrence of the dip can be further suppressed, and an acoustic diaphragm can be obtained, which achieves the improvement of the audio frequency band from the midrange band to the treble band.

As a result, in the example shown in FIGS. 11A and 11B, the diaphragm 11e is formed, in which the first plate thickness area D3 is formed into the double-layer stack structure of the wood sheet 23 and the paper sheet 24, the second plate thickness area D3-1 is formed into the single-layer structure of the synthetic resin film 25, and the third plate thickness area D3-2 is formed into the triple-layer stack structure of the wood sheet 23, the paper sheet 24, and the synthetic resin film 25.

Note that, in FIGS. 11A and 11B, the third plate thickness area D3-2 is defined to include a specified area (outer circumferential portion of the center vibrating portion 19) continuous with the coupling portion of the center vibrating portion 19 to the outer circumferential vibrating portion 21, and to include a specified area (inner circumferential portion of the outer circumferential vibrating portion 21) continuous with the coupling portion of the outer circumferential vibrating portion 21 to the center vibrating portion 19.

However, a diaphragm in which the third plate thickness area D3-2 is defined to include one of the coupling portion 20 and the outer circumferential portion of the center vibrating portion 19, that is, a diaphragm in which the thicknesses of the outer circumferential portion of the center vibrating portion 10 and the coupling portion 20 are set particularly thicker than those of the other areas can also be suitably used. Alternatively, a diaphragm in which the third plate thickness area D3-2 is defined to include the coupling portion 20 and the inner circumferential portion of the outer circumferential vibrating portion 21, that is, a diaphragm in which the width of L is made large and the center vibrating portion 19 is substantially composed only of the wood sheet 23 and the paper sheet 24, or the like exerts similar functions and effects to those of FIGS. 11A and 11B, and can be suitably used.

In accordance with the electroacoustic transducer 1B according to the second embodiment, by the stack structure in which the wood sheet 23 made of the natural wood and the paper sheet 24 approximate in property to the wood are combined, the natural timber intrinsic to the wood can be obtained, and in addition, the appearance of the diaphragm 11e is enhanced by the woodgrain tone owned by the wood. In such a way, the diaphragms 11c and 11e become an extremely preferable one in appearance quality.

Meanwhile, each of the diaphragms 11c and 11e enters the piston vibration band where the diaphragm concerned vibrates entirely from, as the point of support, the second plate thickness area D3-1 formed into the thin plate. Accordingly, the frequency characteristics of the output sound pressure can be made flat. Moreover, by the thick plate thickness shape of the coupling portion 20 including the center vibrating portion and the outer circumferential vibrating portion, the rigidity of the coupling portion can be increased, the flat frequency band can be widened, further, the antiphase vibrations owing to the resonance can be suppressed to be small, and the improvement of the sound pressure dip can be achieved. At the same time, also in the treble band, by the diaphragm composed of the stack structure of the wood sheet in which the surface propagation velocity (sound velocity) is fast and of the paper sheet, the complicated divided vibrations of the diaphragm can be suppressed to be small, and the improvement of the peak dip can be achieved.

Desirably, the surface of the center vibrating portion 19 is formed of the material in which the sound propagation velocity is fast. As the material for use in the diaphragm, the wood sheet 23 is extremely suitable since the sound propagation velocity equivalent to that of metal can be obtained by the lightweight material having a density similar to that of paper. Moreover, the wood sheet includes the wood fiber, and accordingly, has anisotropy in the structure thereof, has the internal loss of which magnitude is appropriate, and can suppress the occurrence of the resonant vibrations and the divided vibrations. However, in terms of managing the weight, when the wood sheet 23 is processed to be as thin as possible, the strength thereof in the direction perpendicular to the fiber becomes weakened, and accordingly, it is necessary to reinforce the wood sheet 25 by the paper sheet having good adhesion bonding therewith. Hence, an acoustic effect by using the above-described wood sheet 23 can be obtained by forming the center vibrating portion 10 into the at least double-layer stack structure. Moreover, the plate thickness area is expanded to the coupling portion 20, thus making it possible to obtain the stable piston vibrations.

Meanwhile, the outer circumferential vibrating portion 21 can be defined as the spring portion when the diaphragm makes the piston vibrations as described above, and accordingly, it is desirable to select physical property values of the resin film. Therefore, the single-layer structure of the synthetic resin film 25 is suitable, which is thin and lightweight, has hermetical sealing property, has appropriate rigidity and shape restorability, and good press formability.

When the plural-layer structures, for example, the triple-layer structure in the first plate thickness area D3, and the double-layer structure in the third plate thickness area D3-2, are adopted, not only the above-described effects can be extracted, but also excellent shape retention is brought, that is, a configuration excellent in productivity of the diaphragms 11c and 11e are obtained.

### Third Embodiment

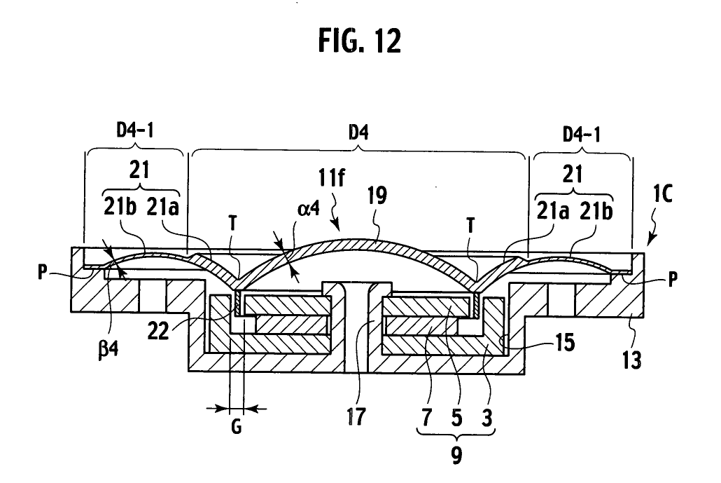

As shown in FIG. 12, an electroacoustic transducer 1C according to a third embodiment is different from the electroacoustic transducer 1 shown in FIG. 1 in including a diaphragm 11f.

The diaphragm 11f includes: the center vibrating portion 19 having a substantial dome shape in cross section; and the outer circumferential vibrating portion 21 formed to be integrally continuous with the outer circumference of the center vibrating portion 19. Onto a back surface of a boundary T continuous with the outer circumferential vibrating portion 21 from the center vibrating portion 19, the voice coil 22 is joined and supported through the adhesive while being centered by the drop-in in the gap G. Meanwhile, the outer circumferential vibrating portion 21 includes the plate portion 21a with the same thickness as that of the center vibrating portion 19, and of the edge portion 21b with a plate thickness thinner than the thickness of the plate portion 21a. A support structure is adopted, in which the circumferential end edge P of the edge portion 21b is adhered onto the outer circumferential edge of the frame 13 by the adhering means such as the adhesive.

As shown in FIG. 12, the area (second plate thickness area) D4-1 of the edge portion 21b of the outer vibrating portion 21 is formed to have a plate thickness thinner than the thickness α4 of the area (first plate thickness area) D4 including the center vibrating portion 19 and the plate thickness portion 21a of the outer circumferential vibrating portion 21. Then, the area D4-1 is formed to have the plate thickness β4 at which the piston vibration band where the diaphragm vibrates from the area D4-1 of the edge portion 21b as the point of support is made and the sound pressure dip that becomes a trough is suppressed to be small.

The plate thickness dimension α4 is not particularly limited; however, can be set, for example, at approximately from 5 Mm to 250 Mm considering the necessary weight and stiffness, for example, in the case of using the headphone and the earphone.

Moreover, with regard to the first plate thickness area D4 composed of the center vibrating portion 19 and the plate thickness portion 21a of the outer circumferential vibrating portion 21, which exclude the edge portion 21b, the thickness thereof is set at the plate thickness dimension β4 at which the antiphase vibrations mutually canceling the sounds of the center vibrating portion 19 and the outer circumferential vibrating portion 21 are suppressed to be small on the boundary T continuous with the outer circumferential vibrating portion 21 from the center vibrating portion 19.

The plate thickness dimension β4 is not particularly limited; however, can be set, for example, at approximately from 4 μm to 40 μm from a viewpoint of managing the weight and ensuring the stiffness, for example, in the case of using the diaphragm for the headphone and the earphone.

The diaphragm 11f of FIG. 12 has a single-layer structure formed of a synthetic resin film. As a material of the synthetic resin film, polyethylene terephthalate (PET), polyethylene naphthalate (PEN), polyetherimide (PEI), polyimide (PI), and the like are suitably used. Moreover, the nonwoven fabric of vinylon-series fiber formed by a mixture of the artificial material and the natural material, the sheet made of the Japanese paper (washi) from gampi tree, paper mulberry, or the like, or further, the wood sheet, which are the natural material, can be used.

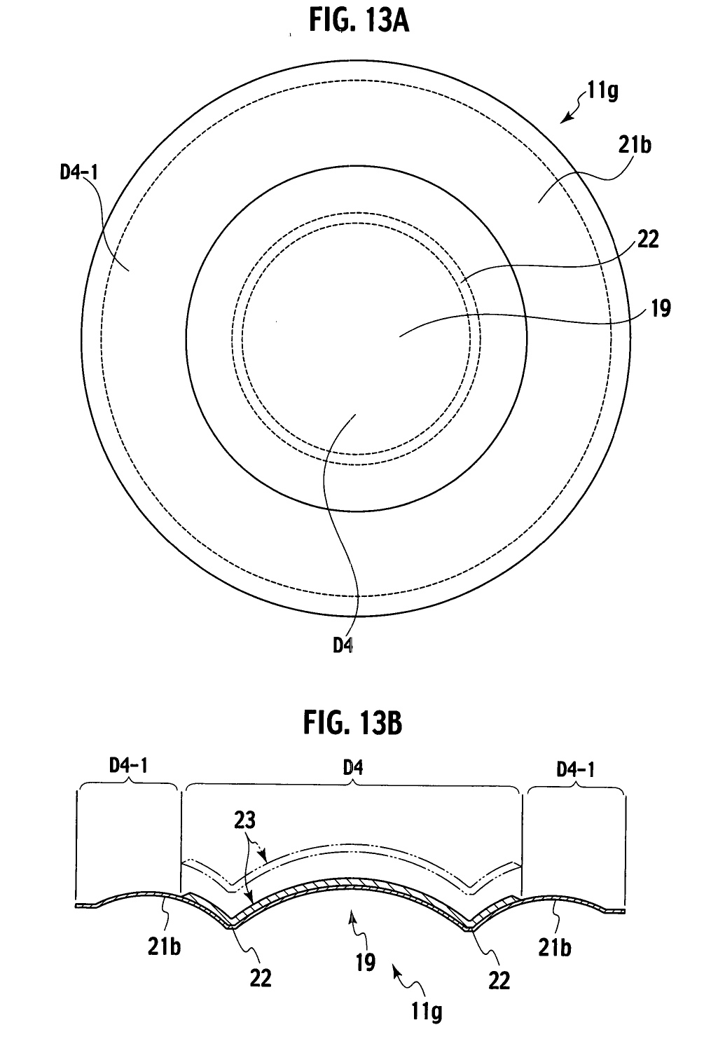

Note that, as shown in FIG. 13A and FIG. 13B, a diaphragm 11g may be formed into a stack structure, in which the center vibrating portion 19 and the outer circumferential vibrating portion 21 on the outer circumference of the center vibration portion 19 are formed of thin plates, and the wood sheet 23 is stacked thereon.

For example, the wood sheet 23 is fabricated by bringing the cutting blade into contact with the log-like wood while rotating the wood and performing the rotary slice (rotary lathe) therefor. Moreover, the wood sheet 23 can also be fabricated by performing the slice process for the flat-grained plate material or the straight-grained plate material.

As the material of the natural wood for use, there is mentioned the material that is easy to be fabricated as well as satisfies the conditions that that the vessel density is even and small, the length of the vessels are short, the wood fiber is long, the growth of the early wood (spring wood) is slow, and so on. In addition, considering the respective conditions of the sound characteristics, for example, that the sound propagation velocity should be fast, and that the appropriately high internal loss should be provided, one that has the anisotropy and the unevenness in addition to the low density and the high rigidity is the optimum. Here, in particular, among the broadleaf woods, the birch woods (genus Betula) such as the gold birch, as a diffuse-porous wood, that grows in the cold climate area and the highland can be used. Moreover, the Japanese big-leaf magnolia, the maple woods (genus Acer) such as the sugar maple and the hard maple can also be used.

Note that, in the case of the diaphragm 11f shown in FIG. 12, it is difficult to realize, only by the natural wood, the respective conditions necessary to exert the predetermined acoustic characteristics. In the example shown in FIG. 13A and FIG. 13B, considering the press formability and the shape stability, the stack structure is adopted, in which the paper sheet (reinforcement sheet) approximate in property to the wood and the wood sheet are stacked on each other, whereby the respective conditions concerned are achieved.

As the paper sheet, the Japanese paper (washi) from gampi tree, paper mulberry, and the like, which are highly heat-resistant and have high mechanical strength such as high tensile strength, are used. In order to increase the mechanical strength, it is also possible to perform the resin immersion for the paper sheet. With regard to the stacking direction of the wood material and the paper material, fiber directions of both thereof may be parallel to each other, perpendicular to each other, or further, may be random directions.

Moreover, besides the wood material and the paper material, as the diaphragm of the first plate thickness area D4, a thin film can be used, which is made of ceramics or single metal of a metal oxide, a metal nitride, a metal carbide or the like, or an alloy of two or more metals. In the case of a high-density material, it is preferable to thin the diaphragm or to reduce an area thereof in order to achieve a weight reduction.

In FIG. 13A and FIG. 13B, the second plate thickness area D4-1 is formed into a single-layer structure made of a synthetic resin film. As a material of the synthetic resin film, polyethylene terephthalate, polyethylene naphthalate, polyetherimide, polyimide, and the like are used. The thickness of the second plate thickness area D4-1 is set at the thickness β4 at which the diaphragm 11 enters the piston vibration band where the diaphragm concerned vibrates entirely. Note that it is also possible to form the second plate thickness area D4-1 into a stacked body with a single synthetic resin, a wood material, a paper material, a ceramic material, or a metal or alloy material.

In accordance with the electroacoustic transducer 1C according to the third embodiment, the diaphragm 11f composed of the center vibrating portion 19 and the outer circumferential vibrating portion 21 on the outer circumference of the center vibration portion 19 is made capable of suppressing the antiphase vibrations particularly in the midrange band by the edge portion 21b formed into the thin plate, and can achieve the improvement of the sound pressure dip d. Moreover, the diaphragm 11f can suppress the complicated divided vibrations to be small by the thick plate thickness in the treble band, and can achieve the improvement of the peak dip.

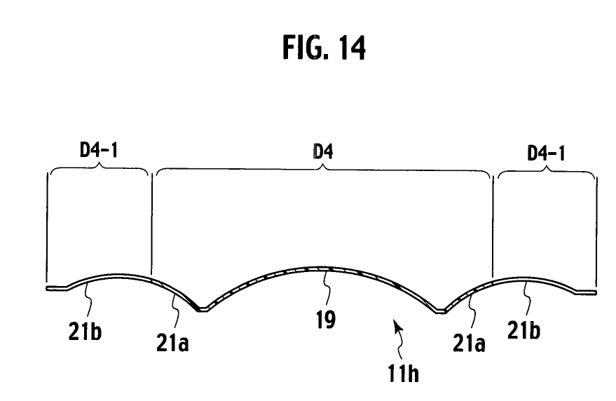

Note that each of the diaphragms 11f and 11g in FIG. 12, FIG. 13A and FIG. 13B forms the embodiment in which the means of the integral structure or the stack structure is adopted in order to fabricate the thick plate thickness area D4 and the thin plate thickness area D4-1; however, a diaphragm 11h shown in FIG. 14 may be adopted. Specifically, in an example shown in FIG. 14, the center vibrating portion 19 and the outer circumferential vibrating portion 21 on the outer circumference thereof are fabricated in a similar way to the above-described embodiments; however, a portion corresponding to the first plate thickness area D4 with the thick plate thickness is formed of a harder material than the second plate thickness area D4-1 with the thin plate thickness. Meanwhile, a portion corresponding to the second plate thickness area D4-1, that is, to the edge portion 21b is formed into a diaphragm 11h with an integral structure, which is formed of a soft flexible material. Note that, in this case, it is also possible to set the plate thickness of the first plate thickness area D4 to be equivalent to or smaller than the second plate thickness area D4-1.

As the “hard material”, for example, the paper, the wood, and the like, which are described above, are usable. In a similar way, as the “soft material” the paper and the wood are usable similarly, and further, the synthetic resin of polyethylene terephthalate, polyethylene naphthalate, polyetherimide, or polyimide is usable.

Note that the diaphragm 11h shown in FIG. 14 can be fabricated in such a manner that a block of a columnar hard material corresponding to the plate thickness area D4 and a block of a soft material, which is brought into contact with an outer circumference of the hard material block, are joined to each other in advance after both of the blocks are press forming, and the joined, blocks are sliced into a thin layer in the cross-sectional direction, and are formed into a sheet, the obtained sheet is press formed, and an unnecessary outer circumferential portion is removed. Alternatively, in a paper or wood sheet of a single material, a portion thereof that becomes the plate thickness area D4 is subjected to the resin immersion by a thermosetting resin solution of phenol resin or the like, followed by simultaneous thermal setting and molding, and the diaphragm in which the center portion is hard can be manufactured. In such a way, also in the case of using the diaphragm 11h of FIG. 14, the same functions and effects as those of the diaphragms 11f and 11g shown in FIG. 12 and FIGS. 13A and 13B can be obtained.

Various modifications will become possible for those skilled in the art after receiving the teachings of the present disclosure without departing from the scope thereof.

What is claimed is:

1. An electroacoustic transducer comprising:
a magnetic circuit;
a frame enclosing the magnetic circuit; and
a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm comprising:
a first plate thickness area including an entirety of the center vibrating portion, having a double-layer structure of a wood sheet and a reinforcement sheet; and
a second plate thickness area including the edge portion of the outer circumferential vibrating portion, having a plate thickness thinner than a thickness of the first plate thickness area, and having a single-layer structure of the reinforcement sheet.

2. An electroacoustic transducer comprising:
a magnetic circuit;
a frame enclosing the magnetic circuit; and
a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm comprising:
a first plate thickness area including an entirety of the center vibrating portion and a specified area of the outer circumferential vibrating portion being connected to the center vibrating portion, having a double-layer structure of a wood sheet and a reinforcement sheet; and
a second plate thickness area including an area other than the specified area of the outer circumferential vibrating portion, having a plate thickness thinner than a thickness of the first plate thickness area, and having a single-layer structure of the reinforcement sheet.

3. A diaphragm comprising:
a center vibrating portion having a substantial dome shape in a cross section; and
an outer circumferential vibrating portion having a substantial dome shape in the cross section and formed over an entire outer circumference of the center vibrating portion,
wherein the center vibrating portion and the outer circumferential vibrating portion comprising:
a first plate thickness area including an entirety of the center vibrating portion, having a double-layer structure of a wood sheet and a reinforcement sheet; and
a second plate thickness area including the edge portion of the outer circumferential vibrating portion, having a plate thickness thinner than a thickness of the first plate thickness area, and having a single-layer structure of the reinforcement sheet.

4. A diaphragm comprising:
a center vibrating portion having a substantial dome shape in a cross section; and
an outer circumferential vibrating portion having a substantial dome shape in the cross section and formed over an entire outer circumference of the center vibrating portion,
wherein the center vibrating portion and the outer circumferential vibrating portion comprising:
a first plate thickness area including an entirety of the center vibrating portion and a specified area of the outer circumferential vibrating portion being connected to the center vibrating portion, having a double-layer structure of a wood sheet and a reinforcement sheet; and
a second plate thickness area including an area other than the specified area of the outer circumferential vibrating portion, having a plate thickness thinner than a thickness of the first plate thickness area, and having a single-layer structure of the reinforcement sheet.

5. An electroacoustic transducer comprising:
a magnetic circuit;
a frame enclosing the magnetic circuit; and
a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm comprising:
a first plate thickness area including an entirety of the center vibrating portion, having a laminated structure of a wood sheet, a paper sheet and a synthetic resin film; and
a second plate thickness area including the edge portion of the outer circumferential vibrating portion, having a plate thickness thinner than a thickness of the first plate thickness area, and having a single-layer structure of a synthetic resin film.

6. An electroacoustic transducer comprising:
a magnetic circuit;
a frame enclosing the magnetic circuit; and
a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm comprising:
a first plate thickness area including an entirety of the center vibrating portion and a specified area of the outer circumferential vibrating portion being connected to the center vibrating portion, having a laminated structure of a wood sheet, a paper sheet and a synthetic resin film; and
a second plate thickness area including an area other than the specified area of the outer circumferential vibrating portion, having a plate thickness thinner than a thickness of the first plate thickness area, and having a single-layer structure of a synthetic resin film.

7. A diaphragm comprising:
a center vibrating portion having a substantial dome shape in a cross section; and
an outer circumferential vibrating portion having a substantial dome shape in the cross section and formed over an entire outer circumference of the center vibrating portion,
wherein the center vibrating portion and the outer circumferential vibrating portion comprising:
a first plate thickness area including an entirety of the center vibrating portion, having a laminated structure of a wood sheet, a paper sheet and a synthetic resin film; and
a second plate thickness area including the edge portion of the outer circumferential vibrating portion, having a plate thickness thinner than a thickness of the first plate thickness area, and having a single-layer structure of the synthetic resin film.

8. A diaphragm comprising:
a center vibrating portion having a substantial dome shape in a cross section; and
an outer circumferential vibrating portion having a substantial dome shape in the cross section and formed over an entire outer circumference of the center vibrating portion,
wherein the center vibrating portion and the outer circumferential vibrating portion comprising:
a first plate thickness area including an entirety of the center vibrating portion and a specified area of the outer circumferential vibrating portion being connected to the center vibrating portion, having a laminated structure of a wood sheet, a paper sheet and a synthetic resin film; and a second plate thickness area including an area other than the specified area of the outer circumferential vibrating portion, having a plate thickness thinner than a thickness of the first plate thickness area, and having a single-layer structure of the synthetic resin film.

9. An electroacoustic transducer comprising:
a magnetic circuit;
a frame enclosing the magnetic circuit; and
a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm comprising:
a first plate thickness area including a center portion of the center vibrating portion;
a second plate thickness area including the edge portion of the outer circumferential vibrating portion, having a plate thickness thinner than a thickness of the first plate thickness area; and
a third plate thickness area between the first and second plate thickness areas, including a specified area of the center vibrating portion being connected to the outer circumferential vibrating portion, and having a plate thickness thicker than the first plate thickness area.

10. An electroacoustic transducer comprising:
a magnetic circuit;
a frame enclosing the magnetic circuit; and
a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm comprising:
a first plate thickness area including a center portion of the center vibrating portion;
a second plate thickness area including the edge portion of the outer circumferential vibrating portion, having a plate thickness thinner than a thickness of the first plate thickness area; and
a third plate thickness area between the first and second plate thickness areas, including a specified area of the outer circumferential vibrating portion being connected to the center vibrating portion, and having a plate thickness thicker than the first plate thickness area.

11. An electroacoustic transducer comprising:
a magnetic circuit;
a frame enclosing the magnetic circuit; and
a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm comprising:
a first plate thickness area including a center portion of the center vibrating portion;
a second plate thickness area including the edge portion of the outer circumferential vibrating portion, having a plate thickness thinner than a thickness of the first plate thickness area; and
a third plate thickness area between the first and second plate thickness areas, including a first specified area of the center vibrating portion being connected to the outer circumferential vibrating portion and a second specified area of the outer circumferential vibrating portion being connected to the center vibrating portion, and having a plate thickness thicker than the first plate thickness area.

12. A diaphragm comprising:
a center vibrating portion having a substantial dome shape in a cross section; and
an outer circumferential vibrating portion having a substantial dome shape in the cross section and formed over an entire outer circumference of the center vibrating portion,
wherein the center vibrating portion and the outer circumferential vibrating portion comprising:
a first plate thickness area including a center portion of the center vibrating portion;
a second plate thickness area including the edge portion of the outer circumferential vibrating portion, having a plate thickness thinner than a thickness of the first plate thickness area; and
a third plate thickness area between the first and second plate thickness areas, including a specified area of the center vibrating portion being connected to the outer circumferential vibrating portion, and having a plate thickness thicker than the first plate thickness area.

13. A diaphragm comprising:
a center vibrating portion having a substantial dome shape in a cross section; and
an outer circumferential vibrating portion having a substantial dome shape in the cross section and formed over an entire outer circumference of the center vibrating portion,
wherein the center vibrating portion and the outer circumferential vibrating portion comprising:
a first plate thickness area including a center portion of the center vibrating portion;
a second plate thickness area including the edge portion of the outer circumferential vibrating portion, having a plate thickness thinner than a thickness of the first plate thickness area; and
a third plate thickness area between the first and second plate thickness areas, including a specified area of the outer circumferential vibrating portion being connected to the center vibrating portion, and having a plate thickness thicker than the first plate thickness area.

14. A diaphragm comprising:
a center vibrating portion having a substantial dome shape in a cross section; and
an outer circumferential vibrating portion having a substantial dome shape in the cross section and formed over an entire outer circumference of the center vibrating portion,
wherein the center vibrating portion and the outer circumferential vibrating portion comprising:
a first plate thickness area including a center portion of the center vibrating portion;
a second plate thickness area including the edge portion of the outer circumferential vibrating portion, having a plate thickness thinner than a thickness of the first plate thickness area; and
a third plate thickness area between the first and second plate thickness areas, including a first specified area of the center vibrating portion being connected to the outer circumferential vibrating portion and a second specified area of the outer circumferential vibrating portion being connected to the center vibrating portion, and having a plate thickness thicker than the first plate thickness area.

15. An electroacoustic transducer comprising:
a magnetic circuit;
a frame enclosing the magnetic circuit; and
a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm comprising:
a first plate thickness area including an entirety of the center vibrating portion; and
a second plate thickness area including the edge portion of the outer circumferential vibrating portion, having a plate thickness thinner than a thickness of the first plate thickness area.

16. An electroacoustic transducer comprising:
a magnetic circuit;
a frame enclosing the magnetic circuit; and
a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm comprising:
a first plate thickness area including an entirety of the center vibrating portion and a specified area of the outer circumferential vibrating portion being connected to the center vibrating portion; and
a second plate thickness area including an area other than the specified area of the outer circumferential vibrating portion, having a plate thickness thinner than a thickness of the first plate thickness area.

17. The electroacoustic transducer of claim 15, wherein the diaphragm includes a single-layer structure.

18. The electroacoustic transducer of claim 15, wherein the first plate thickness area includes a plurality of layers and the second plate thickness area includes at least one layer, the number of the layers of the second plate thickness area is less than the number of layers of the first plate thickness area.

19. A diaphragm comprising:
a center vibrating portion having a substantial dome shape in a cross section; and
an outer circumferential vibrating portion having a substantial dome shape in the cross section and formed over an entire outer circumference of the center vibrating portion,
wherein the center vibrating portion and the outer circumferential vibrating portion comprising:
a first plate thickness area including an entirety of the center vibrating portion; and
a second plate thickness area including the edge portion of the outer circumferential vibrating portion, having a plate thickness thinner than a thickness of the first plate thickness area.

20. A diaphragm comprising:
a center vibrating portion having a substantial dome shape in a cross section; and
an outer circumferential vibrating portion having a substantial dome shape in the cross section and formed over an entire outer circumference of the center vibrating portion,
wherein the center vibration portion and the outer circumferential vibrating portion comprising:
a first plate thickness area including an entirety of the center vibrating portion and a specified area of the outer circumferential vibrating portion being connected to the center vibrating portion; and
a second plate thickness area including an area other than the specified area of the outer circumferential vibrating portion, having a plate thickness thinner than a thickness of the first plate thickness area.

21. The diaphragm of claim 19, wherein the center vibrating portion and the outer circumferential vibration portion include a single-layer structure.

22. The diaphragm of claim 19, wherein the first plate thickness area includes a plurality of layers and the second plate thickness area includes at least one layer, the number of the layers of the second plate thickness area is less than the number of layers of the first plate thickness area.

23. An electroacoustic transducer comprising:
a magnetic circuit;
a frame enclosing the magnetic circuit; and
a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the diaphragm comprising:
a first area including an entirety of the center vibrating portion; and
a second area including the edge portion of the outer circumferential vibrating portion, having flexibility, and formed of a material softer than a material of the first area.

24. An electroacoustic transducer comprising:
a magnetic circuit;
a frame enclosing the magnetic circuit; and
a diaphragm including a center vibrating portion having a substantial dome shape in a cross section, and an outer circumferential vibrating portion having a substantial dome shape in the cross section and formed over an entire outer circumference of the center vibrating portion, an end of an edge portion on an outer circumference side of the outer circumferential vibrating portion is fixed to the frame, the
diaphragm comprising:
a first area including an entirety of the center vibrating portion and a specified area of the outer circumferential vibrating portion being connected to the center vibrating portion; and
a second area including an area other than the specified area of the outer circumferential vibrating portion, having flexibility, and formed of a material softer than a material of the first area.

25. A diaphragm comprising:
a center vibrating portion having a substantial dome shape in a cross section; and
an outer circumferential vibrating portion having a substantial dome shape in the cross section and formed over an entire outer circumference of the center vibrating portion,
wherein the center vibrating portion and the outer circumferential vibrating portion comprising:
a first area including an entirety of the center vibrating portion; and
a second area including the edge portion of the outer circumferential vibrating portion, having flexibility, and formed of a material softer than a material of the first area.

26. A diaphragm comprising:
a center vibrating portion having a substantial dome shape in a cross section; and
an outer circumferential vibrating portion having a substantial dome shape in the cross section and formed over an entire outer circumference of the center vibrating portion,
wherein the center vibrating portion and the outer circumferential vibrating portion comprising:
a first area including an entirety of the center vibrating portion and a specified area of the outer circumferential vibrating portion being connected to the center vibrating portion; and
a second area including an area other than the specified area of the outer circumferential vibrating portion, having flexibility, and formed of a material softer than a material of the first area.
